(19) United States
(12) Patent Application Publication
(10) Pub. No.: US 2024/0429601 A1
(43) Pub. Date: Dec. 26, 2024

(54) FULL ANALOG PHASE SHIFTER

(71) Applicant: KMW INC., Hwaseong-si (KR)

(72) Inventors: Sung Hwan SO, Hwaseong-si (KR); Eui Song CHOI, Hwaseong-si (KR); Seong Man KANG, Hwaseong-si (KR); Dong Hee SHIN, Incheon (KR); Hwa Yeol JANG, Incheon (KR); Yong Won SEO, Daejeon (KR); Won Jun PARK, Yongin-si (KR); Gyo Jin JO, waseong-si (KR)

(73) Assignee: KMW INC., Hwaseong-si (KR)

(21) Appl. No.: 18/827,884

(22) Filed: Sep. 9, 2024

Related U.S. Application Data
(63) Continuation of application No. PCT/KR2023/003154, filed on Mar. 8, 2023.

(30) Foreign Application Priority Data
Mar. 10, 2022 (KR) 10-2022-0030247
Mar. 7, 2023 (KR) 10-2023-0029718

(51) Int. Cl. H01Q 3/36; H01Q 1/38

(52) U.S. Cl. CPC H01Q 3/36; H01Q 1/38

(57) ABSTRACT

The present invention relates to a full analog phase shifter, and more particularly, comprises: a variable switch panel comprising a first conductive pattern terminal and a second conductive pattern terminal; and a pattern PCB on which a plurality of array antenna elements are arranged and a transmission line at which the first conductive pattern terminal and the second conductive pattern terminal come into contact is pattern-printed, wherein, assuming that two variable switch panels are disposed in the vertical direction, the two variable switch panels are provided as a slider type that slides in the vertical direction so that, due to a phase shift caused by the contact between the first conductive pattern terminal and the second conductive pattern terminal and the transmission line, phases of the plurality of array antenna elements are linearly distributed on a same reference phase plane, thereby providing the advantage of easily implementing a mirror symmetry structure having a linear phase distribution only by a phase shift in an RF stage without phase conversion in a digital stage.

### TECHNICAL FIELD

The present disclosure relates to a full analog phase shifter, and more particularly, to a full analog phase shifter that is provided in an RF stage, but can secure a desired phase shift value by selectively changing a total length of transmission lines without a change in the arrangement and design of the existing RF module and also a need to design a separate installation space.

### BACKGROUND ART

In local and foreign mobile communication systems, network management in which coverage of a base station is adjusted by adjusting the angle of a vertical beam of a base station antenna is performed in order to provide an optimal service in a situation in which the density of use of subscribers is changed for each region and each time zone.

To this end, a mechanical beam tilt method was used in a conventional wireless communication system. The mechanical beam tilt method is a method of directly adjusting the direction of an antenna radiation beam by adjusting the angle of an antenna by using a mechanical beam tilt apparatus mounted on the antenna.

An advantage of the mechanical beam tilt method is to reduce a production cost for the antenna. However, for the management of a base station, a complicated process of a technician directly climbing a base station antenna tower, loosening several bolts that fix beam tilt instrument, changing the angle of the antenna, and then fastening the bolts again needs to be performed. Accordingly, there is a danger, such as a fall, and the rapidness of repairs is low because a lot of time is taken.

Recently, in order to supplement the disadvantage of the mechanical beam tilt method, a mechanical beam tilt apparatus using a remote adjustment method capable of remotely adjusting the mechanical beam tilt apparatus by tilting or steering is developed.

However, the mechanical beam tilt apparatus using the remote adjustment method adjusts the direction of an antenna radiation beam through an operation of mechanically adjusting the entire antenna by tilting or steering and uses an antenna radiation beam adjustment method that is fundamentally different from the electrical beam tilt method. An electrical beam tilt antenna includes a phase shifter for adjusting the phase of a beam therein.

FIG. 1 is a schematic diagram for describing a physical phase shift principle using a phase shifter. FIG. 2 is a circuit diagram and phase shift diagram for describing the principle of a phase shift form that is performed in an RF stage.

Referring to FIG. 1, when the physical length of a transmission line through which a power feed signal passes is changed, the phase of the power feed signal is changed by a physical length variation ΔL. If a phase difference is implemented in an RF stage by using the principle, a phase shift (offset support task) in a digital stage is accompanied as illustrated in FIG. 2.

Specifically, as illustrated in FIG. 2, when a phase difference is applied to one of two output ends that are branched from the RF stage by ΔΦ, there is a problem in that a uniform phase difference needs to be implemented with respect to a desired phase surface, that is, the offset support task needs to be generally performed on one of two input ends by −2ΔΦ in order to achieve a linear phase distribution.

### DISCLOSURE

### Technical Problem

The present disclosure has been contrived to solve the technical problems, and an object of the present disclosure is to provide a full analog phase shifter capable of implementing a linear phase distribution having mirror symmetry by only a phase shift in an RF stage without a phase shift in a digital stage.

Objects of the present disclosure are not limited to the aforementioned objects, and the other objects not described above may be evidently understood from the following description by those skilled in the art.

### Technical Solution

A full analog phase shifter according to an embodiment of the present disclosure includes a variable switch panel including a first electrical conduction pattern terminal and a second electrical conduction pattern terminal, and a pattern PCB on which multiple array antenna elements are disposed and transmission lines with which the first electrical conduction pattern terminal and the second electrical conduction pattern terminal come into contact are patternized and printed. Assuming that the two variable switch panels are disposed in up and down directions thereof, the two variable switch panels are provided in a slider type in which the two variable switch panels slide in the up and down vertical directions so that a phase for the multiple array antenna elements has a linear distribution on a reference same phase surface by a phase shift according to contact points between the first electrical conduction pattern terminal and the second electrical conduction pattern terminal and the transmission lines.

In this case, the two variable switch panels may be provided to simultaneously slide an identical distance in the up and down vertical directions.

Furthermore, the full analog phase shifter may further include a pattern transmission line that is connected to the pattern PCB and that includes a one-side transmission line and the other-side transmission line that are electrically connected to the multiple array antenna elements for power feeding.

Furthermore, the one-side transmission line and the other-side transmission line may be provided in upper and lower parts of the pattern PCB, respectively, and may each be branched into two from an output end corresponding to each front end thereof and may be extended. The singular number of array antenna elements, among the multiple array antenna elements, may be connected to a pair of extension ends that is branched from the output end and disposed at an identical height, for power feeding.

Furthermore, the first electrical conduction pattern terminal and second electrical conduction pattern terminal of the variable switch panel may come into contact with an inner variable circuit prior to a branch from two input ends to a long-side feeding connection end and a short-side feeding connection end that are connected to the one-side transmission line and other-side transmission line of the pattern transmission lines and an outer variable circuit after the branch, respectively.

Furthermore, the long-side feeding connection end and the short-side feeding connection end related to each of the two input ends may be provided to have a length ratio of a predetermined ratio. The predetermined ratio may be 1:3.

Furthermore, the inner variable circuit and the outer variable circuit may be patternized and printed to have a first power failure point and a second power failure point at each of which a part of the transmission line between the long-side feeding connection end and the short-side feeding connection end from each of the input ends has been broken. The first electrical conduction pattern terminal of the variable switch panel may make electrically conductive the first power failure point corresponding to the inner variable circuit. The second electrical conduction pattern terminal of the variable switch panel may make electrically conductive the second power failure point corresponding to the outer variable circuit.

Furthermore, a first output end and a third output end that are branched from a first input end of the two input ends may be arranged to be spaced apart from each other in a vertical (V) direction on a left side of the pattern PCB.

Furthermore, a second output end and a fourth output end that are branched from a second input end of the two input ends may be arranged to be spaced apart from each other in a vertical (V) direction on a right side of the pattern PCB.

Furthermore, assuming that the two pattern PCBs are arranged to be spaced apart from each other in the vertical direction, the two variable switch panels may also be provided to be spaced apart from each other in the vertical direction so that the two variable switch panels simultaneously operated. A vertical phase difference at each output end by the simultaneous operation of the two variable switch panels may have a straight line tilt distribution with respect to the reference same phase surface.

Furthermore, the full analog phase shifter may further include a phase shift driving motor provided on a rear surface side of an antenna element mounting panel in which the variable switch panel and the pattern PCB are installed, a horizontal mounting bar driven in the up and down directions by receiving a driving force of the phase shift driving motor, and multiple vertical mounting bars connected to two variable switch panels provided to be spaced apart from each other in the vertical direction and each having one end connected to the horizontal mounting bar and the other end vertically extended upward or downward.

Furthermore, the two variable switch panels may be disposed to be spaced apart from each other at a predetermined distance in a horizontal (H) direction in multiple columns. The multiple vertical mounting bars may be provided in the horizontal mounting bar so that the multiple vertical mounting bars simultaneously connect the two variable switch panels that are disposed in multiple columns in the horizontal direction.

Furthermore, the horizontal mounting bar may include a rear mounting bar provided to slide and move up and down through a medium of an up and down moving block screwed onto a screw rod that is connected to a rotation shaft of the phase shift driving motor, and a front mounting bar coupled to a front surface side of the antenna element mounting panel so that the front mounting bar operates in conjunction with the rear mounting bar.

Furthermore, a sliding guide hole that provides guidance to the up and down moving of the rear mounting bar and the front mounting bar may be formed in the antenna element mounting panel.

Furthermore, the antenna element mounting panel may include a reflecting panel, a front mounting panel disposed on a front surface of the reflecting panel, and a rear mounting panel disposed on a rear surface of the reflecting panel. The sliding guide hole may be formed in the reflecting panel corresponding to an outside of left ends and right ends of the front mounting panel and the rear mounting panel.

### Advantageous Effects

The full analog phase shifter according to an embodiment of the present disclosure has an effect in that a phase difference having a mirror symmetry structure can be implemented even without requiring a support task in a digital stage.

### DESCRIPTION OF DRAWINGS

FIG. 1 is a schematic diagram for describing a physical phase shift principle using a phase shifter.

FIG. 2 is a circuit diagram and phase shift diagram for describing the principle of a phase shift form that is performed in an RF stage.

FIG. 3 is a perspective view illustrating an antenna apparatus to which a full analog phase shifter according to an embodiment of the present disclosure has been applied.

FIGS. 4A and 4B are exploded perspective views of a front part and a rear part in which a radome panel and a radiation element module have been exploded, among components of the antenna apparatus of FIG. 3.

FIGS. 5A and 5B are diagrams illustrating the phase shifter, among the components of FIG. 3, and are exploded perspective views of the front part and the rear part in the state in which the radome panel and an antenna housing part have been removed.

FIG. 6 is a front view and rear view illustrating a form in which the phase shifter has been disposed, among components according to an embodiment of the present disclosure.

FIGS. 7A and 7B are enlarged and exploded perspective views of the front part and the rear part in which a part of FIG. 6 has been exploded.

FIG. 8 is an exploded perspective view and partially enlarged view illustrating the state in which the radome panel, among the components of FIG. 3, has been separated.

FIGS. 9A and 9B are exploded perspective views of the front part and the rear part, illustrating a form in which the switch panel of the phase shifter has been disposed in the pattern PCB of the radiation element module, among the components of FIG. 3.

FIG. 10 is a plan view of FIG. 9A.

FIG. 11 is a circuit diagram and a phase difference diagram for describing the principle of a phase shift form that is performed in an RF stage using the phase shifter of the antenna apparatus according to an embodiment of the present disclosure.

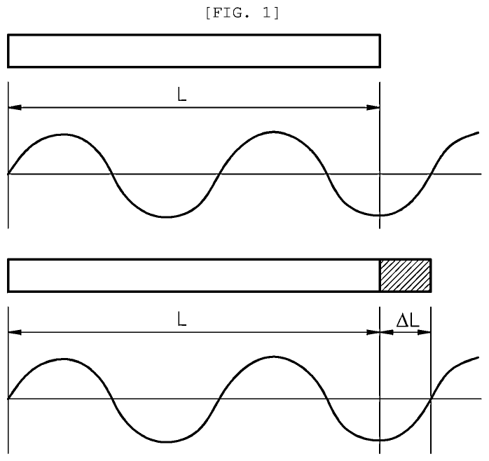

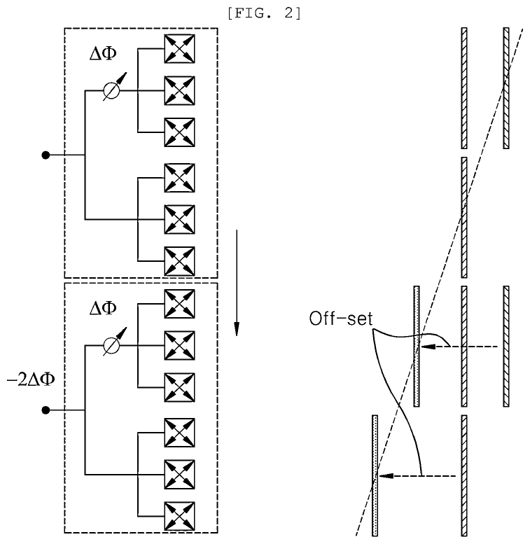

### DESCRIPTION OF REFERENCE NUMERALS

100: antenna apparatus
110: antenna housing part
200: radiation element module
210: antenna element mounting panel
210A: reflecting panel
210B: front mounting panel
210C: rear mounting panel
220: pattern transmission line
222a: one-side transmission line
222b: other-side transmission line
226a: first output end
226b: second output end
226c: third output end
226d: fourth output end
230: pattern PCB
234a: first input end
234b: second input end
238a: long-side feeding connection end
237a: first power failure point
237b: second power failure point
238b: short-side feeding connection end
250: array antenna element
300: radome panel
400: external mounting member
500: phase shifter
510: phase shift driving motor
520: horizontal mounting bar
520A: rear mounting bar
520B: front mounting bar
530: vertical mounting bar
540: variable switch panel
547a: first electrical conduction pattern terminal
547b: second electrical conduction pattern terminal
550: sliding cover
560: horizontal bracket part

### BEST MODE

Hereinafter, a full analog phase shifter according to an embodiment of the present disclosure is described in detail with reference to the accompanying drawings.

In adding reference numerals to the components of each drawing, it should be noted that the same components have the same reference numerals as much as possible even if they are displayed in different drawings. Furthermore, in describing embodiments of the present disclosure, when it is determined that a detailed description of the related well-known configuration or function hinders understanding of an embodiment of the present disclosure, the detailed description thereof will be omitted.

In describing components of an embodiment of the present disclosure, terms, such as a first, a second, A, B, (a), and (b), may be used. Such terms are used only to distinguish one component from another component, and the essence, order, or sequence of a corresponding component is not limited by the terms. All terms used herein, including technical or scientific terms, have the same meanings as those commonly understood by a person having ordinary knowledge in the art to which the present disclosure pertains, unless defined otherwise in the specification. Terms, such as those commonly used and defined in dictionaries, should be construed as having the same meanings as those in the context of a related technology, and are not construed as having ideal or excessively formal meanings unless explicitly defined otherwise in the specification.

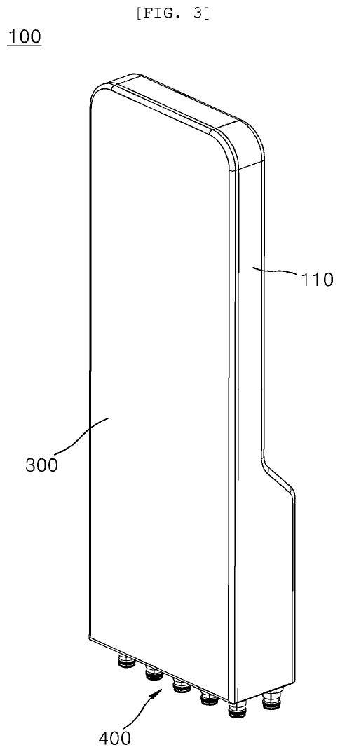

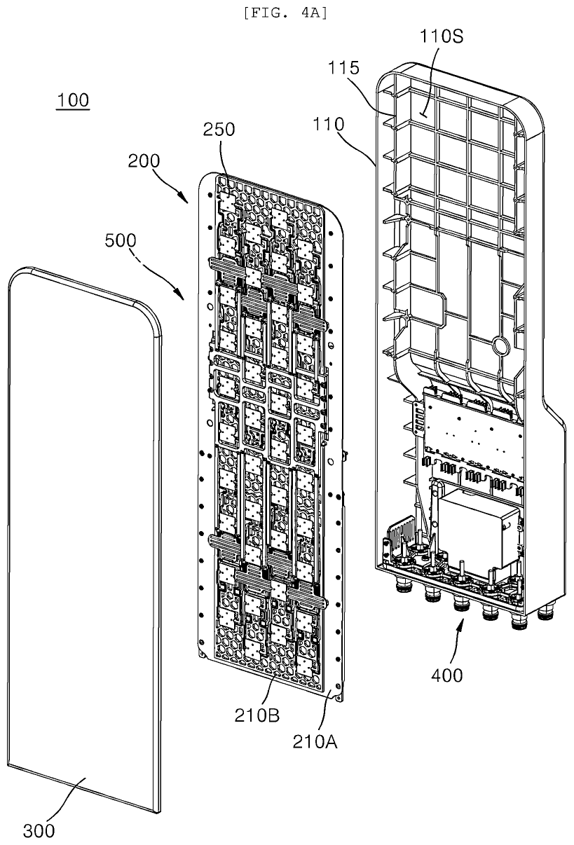

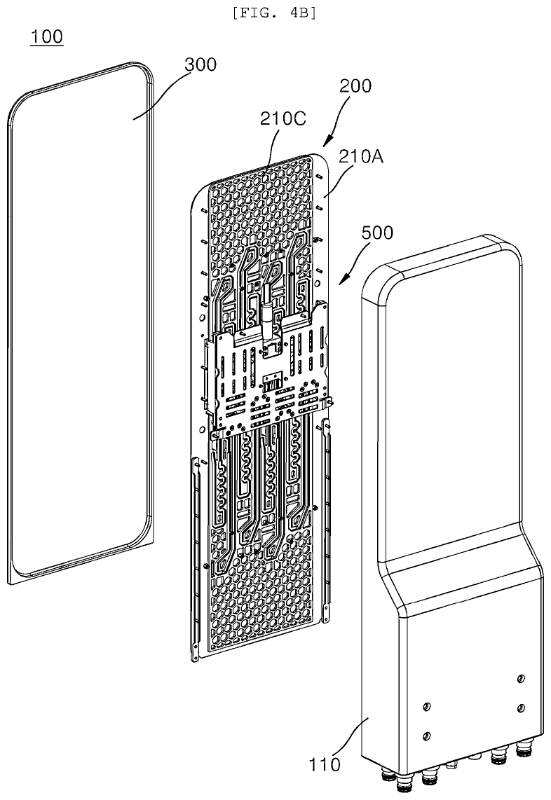

FIG. 3 is a perspective view illustrating an antenna apparatus to which a full analog phase shifter according to an embodiment of the present disclosure has been applied. FIGS. 4A and 4B are exploded perspective views of a front part and a rear part in which a radome panel and a radiation element module have been exploded, among components of the antenna apparatus of FIG. 3.

An antenna apparatus 100 according to an embodiment of the present disclosure may be an antenna apparatus to which the multiple input multiple output (MIMO) technology has been incorporated.

The MIMO technology is a technology for significantly increasing a data transmission capacity by using multiple array antenna elements, and is a spatial multiplexing scheme in which a transmitter transmits different data through transmission antennas and a receiver distinguishes between transmission data through proper signal processing. Accordingly, as both the number of transmission antennas and the number of reception antennas are increased, more data can be transmitted because a channel capacity is increased. For example, if the number of antennas is increased to 10, a channel capacity that is about 10 times compared to a current single antenna system is secured by using the same frequency band.

In particular, in the antenna apparatus, a TRx module (not illustrated) that performs transmitter and receiver functions may be vertically (V)-horizontally (H) arranged in an up and down vertical direction and a left and right horizontal direction, and multiple array antenna elements 250 that are electrically connected to each TRx module may be arranged.

In this case, in the MIMO antenna apparatus for mobile communication, in general, the multiple array antenna elements 250 are designed as a plurality of dual polarization antenna module arrays in order to reduce a fading influence according to multiple paths and to perform a polarization diversity function.

More specifically, as referred in FIGS. 3 and 4, the antenna apparatus 100 according to an embodiment of the present disclosure may include an antenna housing part 110 that forms left and right sides and rear appearances of the antenna apparatus 100, and a radome panel 300 that is provided to form a front appearance of the antenna apparatus 100 and to shield an open front surface of the antenna housing part 110 and that protects a radiation element module 200 provided in an internal space 110S of the antenna housing part 110 against the outside.

The antenna housing part 110 may play a role to mediate the coupling of a support pole that is provided to install the antenna apparatus 100, although not illustrated.

However, the antenna apparatus 100 in which an embodiment of the present disclosure is implemented includes only components having relatively low operating heat when a system operates within the antenna housing part 110, and may be implemented as an embodiment in which the antenna apparatus is installed in front of a repeater RRH (not illustrated) and installed in the support pole through the medium of the repeater RRH.

That is, the antenna housing part 110 is a case of an antenna unit that is coupled to a repeater (called as a “radio remote head (RRH)”) that receives a signal from a base station. The radiation element module 200 and other parts except an RF part that is coupled to the repeater RRH may be embedded within the antenna housing part.

Although not illustrated in the drawings, handle parts which may be grasped by a worker so that the worker can carry the antenna apparatus 100 according to an embodiment of the present disclosure or easily manually mount the antenna apparatus on the support pole (not illustrated) or the repeater RRH on the spot may be further installed on both left and right sides of the antenna housing part 110.

Furthermore, various types of external mounting members 400 for the connection of a cable to the repeater RRH (not illustrated) and the coordination of internal parts may be assembled with the outside of the bottom of the antenna housing part 110 so that the external mounting members penetrate the bottom of the antenna housing part. The external mounting member 400 is provided in the form of at least one optical cable connection terminal (socket). The connection terminal of a coaxial cable (not illustrated) may be connected to each optical cable connection terminal.

Meanwhile, the radome panel 300 is coupled to the front end of the antenna housing part 110, and a hook coupling part (not illustrated) thereof that is formed along the edge of the radome panel 300 may be hooked and coupled to a front end trapping rib (not illustrated) of the antenna housing part 110.

The radiation element module 200 may be embedded in the internal space 110S of the antenna housing part 110.

In this case, the radiation element module 200 may be provided to generate at least one polarization of a dual polarization.

As reference in FIG. 4A, multiple support ribs 115 to which an antenna element mounting panel 210 is supported and screwed, among components of the radiation element module 200 that are described later, may be formed in the internal space 110S of the antenna housing part 110 along an edge portion of the inside thereof.

Through the forming of the multiple support ribs 115, the stiffness of the antenna housing part 110 that is molded approximately as a plastic resin material can be increased.

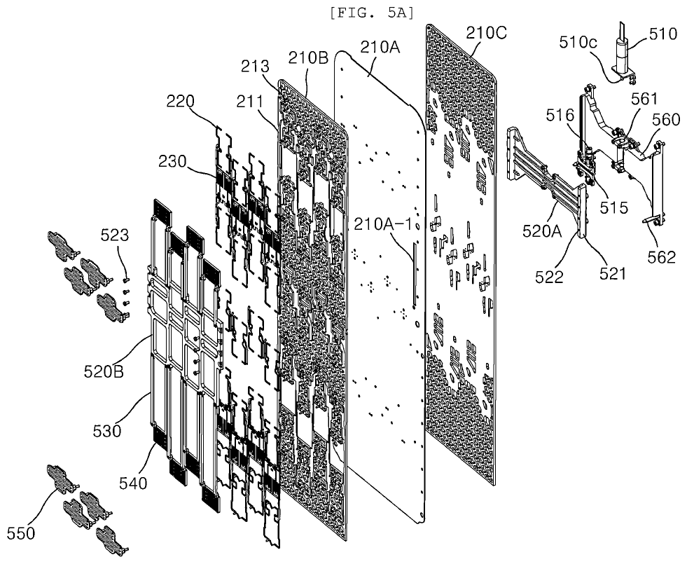

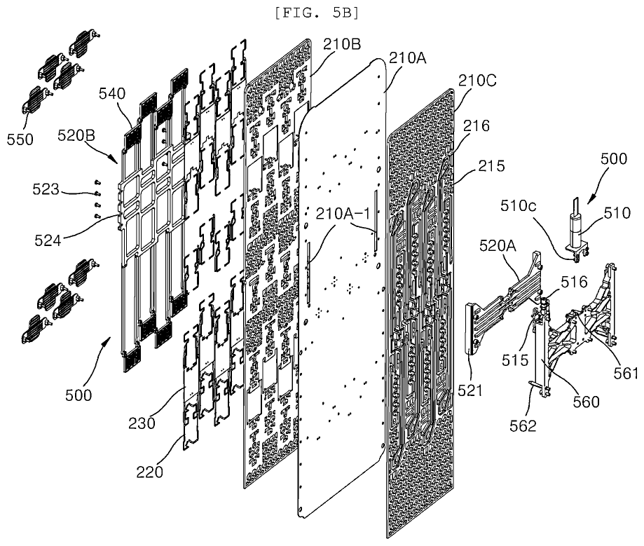

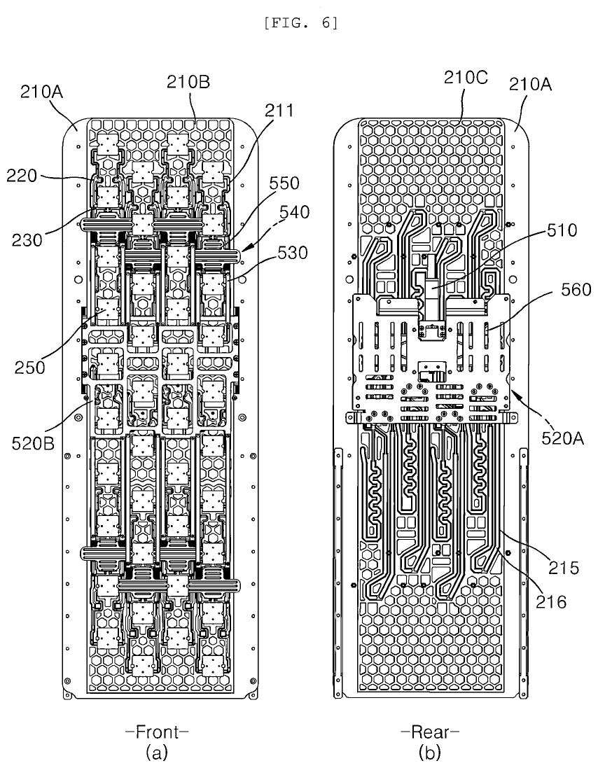

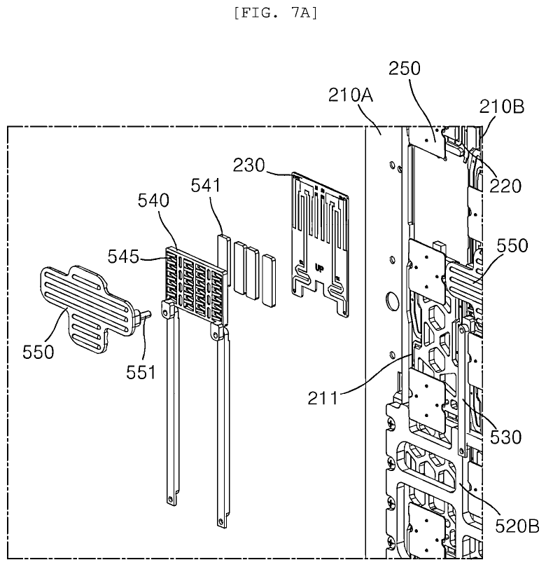

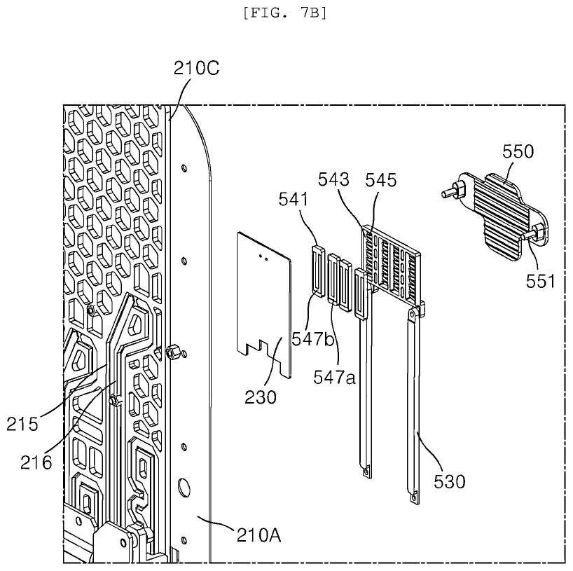

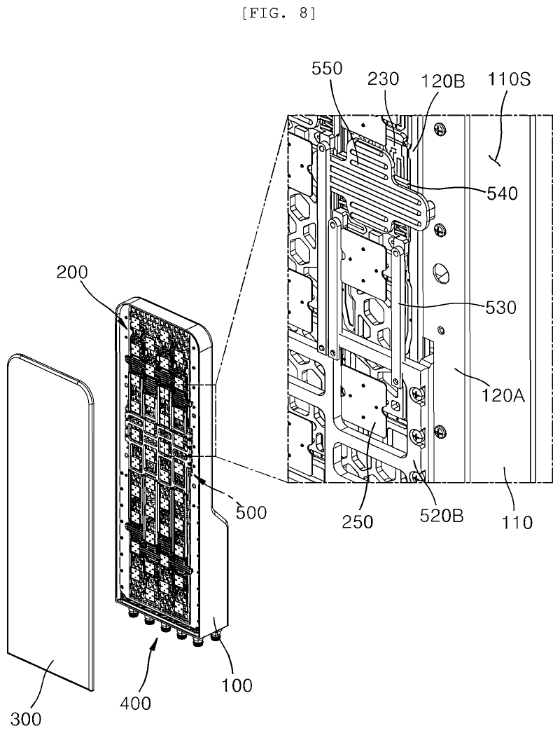

FIGS. 5A and 5B are diagrams illustrating the phase shifter, among the components of FIG. 3, and are exploded perspective views of the front part and the rear part in the state in which the radome panel and the antenna housing part have been removed. FIG. 6 is a front view and rear view illustrating a form in which the phase shifter has been disposed, among components according to an embodiment of the present disclosure. FIGS. 7A and 7B are enlarged and exploded perspective views of the front part and the rear part in which a part of FIG. 6 has been exploded. FIG. 8 is an exploded perspective view and partially enlarged view illustrating the state in which the radome panel, among the components of FIG. 3, has been separated.

As reference in FIGS. 5A and 5B, the radiation element module 200 may include the antenna element mounting panel 210 disposed in the internal space 110S of the antenna housing part 110, and the multiple array antenna elements 250 attached to a front surface of the antenna element mounting panel 210.

As reference in FIGS. 5A and 5B, the antenna element mounting panel 210 may include a reflecting panel 210A disposed at the center, a front mounting panel 210B disposed on a front surface of the reflecting panel 210A, and a rear mounting panel 210C disposed on a rear surface of the reflecting panel 210A.

A line installation slit 211 in which a pattern transmission line 220 that is described later is inserted and installed is formed in the front mounting panel 210B so that the line installation slit penetrates the front mounting panel in forward and backward directions thereof. A pattern PCB 230 and the multiple array antenna elements 250 may be installed on the front surface of the front mounting panel.

An LPF installation slit 215 in which an LPF 216 that is described later is installed is formed in the rear mounting panel 210C so that the LPF installation slit penetrates the rear mounting panel in forward and backward directions thereof. Some components of a full analog phase shifter 500 that is described later may be fixed to a rear part of the rear mounting panel.

The multiple array antenna elements 250 are each formed approximately in a square shape, and may be installed and fixed to multiple mounting pins 213 that are formed in a front surface of the front mounting panel 210B so that the multiple mounting pins protrude from the front surface of the front mounting panel.

In this case, the multiple array antenna elements 250 may implement dual polarization by generating each polarization because the feeding end of each of the pattern transmission lines 220 that are fixed and installed in the line installation slits 211 of the front mounting panel 210B is extended to be disposed at a portion that faces each side of the array antenna element 250 and connected thereto for power feeding. Preferably, each feeding end of the pattern transmission line 220 may be connected to an edge portion of each side of the antenna element 250 in the same direction for power feeding.

In this case, four array antenna elements 250 per TRx module may be disposed to be spaced apart from each other up and down. The four array antenna elements 250 may output two different phase change values by the phase shifter 500 that is described later. This is described more specifically later.

Meanwhile, in the antenna apparatus 100 according to an embodiment of the present disclosure, the radiation element module 200 is limited and described in any one of a patch type and a die pole type, but the present disclosure is not essentially limited thereto.

Furthermore, even in a method of implementing the antenna element mounting panel 210, an air strip type feeding method is limited and described as being applied as described above, but it is to be noted that the method does not exclude the application of a PCB type in which a transmission line (not illustrated) has been patternized and printed. However, an embodiment of the present disclosure is described as an embodiment in which the pattern PCB 230 for operationality and association with the phase shifter 500 that is described later is separately provided.

As reference in FIGS. 3 to 8, the antenna apparatus 100 according to an embodiment of the present disclosure may further include the full analog phase shifter (hereinafter abbreviated as the “phase shifter”) 500 including multiple variable switch panels 540 that change the length of the transmission line by an up and down straight line operation in a separation space (reference numeral not indicated) that is defined between the front surface of the antenna element mounting panel 210 (in particular, the front mounting panel 210B) of the radiation element module 200 and the rear surface of the four array antenna elements 250.

As reference in FIGS. 5A to 8, the phase shifter 500 may further include a phase shift driving motor 510 disposed at the rear of the antenna element mounting panel 210, in particular, the rear part of the rear mounting panel 210C, a horizontal mounting bar 520 that moves in up and down directions thereof by receiving a driving force of the phase shift driving motor 510, and multiple vertical mounting bars 530 each having one end connected to the horizontal mounting bar 520 and having the other end vertically extended upward or downward and connected to each of the multiple variable switch panels 540.

More specifically, referring to FIGS. 5A and 5B, the phase shift driving motor 510 may be fixed to the rear part of the rear mounting panel 210C, among the components of the antenna element mounting panel 210, so that the phase shift driving motor constructs a rotation shaft in up and down directions thereof.

A rotation shaft 510c of the phase shift driving motor 510 may be connected to a screw rod 516 that has a male thread (not illustrated) formed in an outer circumferential surface thereof and that is extended in the direction of the rotation shaft by a predetermined length.

In this case, the phase shifter 500 may further include an up and down moving block 515 in which a rod penetration part (not illustrated) through which the screw rod 516 penetrates in up and down directions thereof is formed and a female thread (not illustrated) fastened to the male thread is formed in the rod penetration part, and that is moved in the up and down directions thereof in the rotation direction of the screw rod 516.

The up and down moving block 515 is fixed to a rear surface of a rear mounting bar 520A, among the components of the horizontal mounting bar 520 that are described later, and may move a front mounting bar 520B connected to the rear mounting bar 520A in the up and down directions, as the rear mounting bar 520A is moved in the up and down directions while operating in conjunction with a movement of the up and down moving block 515 in the up and down directions when the up and down moving block is moved.

Meanwhile, the phase shifter 500 may further include a horizontal bracket part 560 that provides guidance to the up and down moving of the up and down moving block 515 and that is also fixed to left and right side parts of the antenna housing part 110 horizontally left and right so that the horizontal bracket part mediates the installation of the phase shift driving motor 510.

A shaft penetration hole 561 is formed in the horizontal bracket part 560 so that the shaft penetration hole penetrates the horizontal bracket part in the up and down directions. The rotation shaft 510c of the phase shift driving motor 510 may penetrate the shaft penetration hole 561 downward, and may be then coaxially connected to the screw rod 516.

Meanwhile, the horizontal mounting bar 520 may include the mounting bar 520A that is provided on the rear surface side of the rear mounting panel 210C, among the components of the antenna element mounting panel 210, and the front mounting bar 520B that is provided on the front surface side of the front mounting panel 210B, among the components of the antenna element mounting panel 210.

As reference in FIGS. 5A and 5B, the rear mounting bar 520A is fixed to the front end surface of the up and down moving block 515 through a screw assembly using multiple screws, and slides and moves in up and down directions thereof while operating in conjunction with the up and down moving block 515. The front mounting bar 520B may slide and move in the up and down directions, while operating in conjunction with the rear mounting bar 520A, by the fixing of the front mounting bar to screw fastening holes 522 of the guide bars 521 at both ends of the rear mounting bar 520A, which is provided to be forward exposed through the reflecting panel 210A, among the components of the antenna element mounting panel 210, using multiple fastening screws 523.

Up and down sliding guide holes 210A-1 through which guide bars 521 at both ends of the rear mounting bar 520A penetrate may be formed at both ends of the reflecting panel 210A on the left and right sides thereof. Locations at which the up and down sliding guide holes 210A-1 are formed may be set to be disposed at least outside of both left and right ends of each of the front mounting panel 210B and the rear mounting panel 210C.

That is, as referred in FIGS. 5A and 5B, in the antenna element mounting panel 210, the reflecting panel 210A may be formed to have the largest area. The front mounting panel 210B and the rear mounting panel 210C that are integrally stacked and formed on the front surface of the reflecting panel may each be formed to have a small size in a width direction thereof so that a left end and right end of each of the front mounting panel and the rear mounting panel are disposed inside a left end and right end of the reflecting panel 210A.

In this case, a separation distance between the guide bars 521 at both ends of the rear mounting bar 520A in left and right horizontal directions thereof is formed to be at least greater than the size of each of the front mounting panel 210B and the rear mounting panel 210C in the width direction, but may be formed to be smaller than the size of the reflecting panel 210A in a width direction thereof.

In this case, the up and down sliding guide holes 210A-1 are formed in the reflecting panel 210A corresponding to the outsides of the left end and right end of each of the front mounting panel 210B and the rear mounting panel 210C.

One end (defined as “one end’ regardless of a direction thereof in an embodiment of the present disclosure) of each of the multiple vertical mounting bars 530 may be coupled to the front mounting bar 520B of the horizontal mounting bar 520. The other end (defined as “the other end” regardless of a direction thereof in an embodiment of the present disclosure) of each of the multiple vertical mounting bars 530 may be coupled to the variable switch panel 540.

Meanwhile, the variable switch panel 540 is formed approximately in a rectangular panel form, although described more specifically, and an up and down slide and movement thereof may be guided by a sliding cover 550 that is fixed to the front mounting panel 210B by multiple coupling pins 551 so that a front surface of the variable switch panel is covered.

More specifically, first electrical conduction pattern terminals 547a and second electrical conduction pattern terminals 547b that implement a phase difference, while making electrically conductive a first power failure point 237a and a second power failure point 237b (i.e., variable circuits at two places) of the pattern PCB 230 that are described later, may be provided in a rear part of the variable switch panel 540.

In this case, as referred in FIGS. 7A and 7B, the variable switch panel 540 is made of a plastic resin material. Block installation grooves 543 in which multiple terminal blocks 541 on which the first electrical conduction pattern terminals 547a and the second electrical conduction pattern terminals 547b are patternized and printed are installed may be processed and formed in the rear part of the variable switch panel. Multiple elastic ribs 545 that elastically support the multiple terminal blocks 541 toward a front surface of the pattern PCB 230 may be provided within the block installation grooves 543.

The first electrical conduction pattern terminal 547a and the second electrical conduction pattern terminal 547b that are formed in the variable switch panel 540 are each formed in a “⊏” shape in which an upper side or lower side of the pattern terminal is opened, and may be connected to the first power failure point 237a and the second power failure point 237b within the pattern PCB 230.

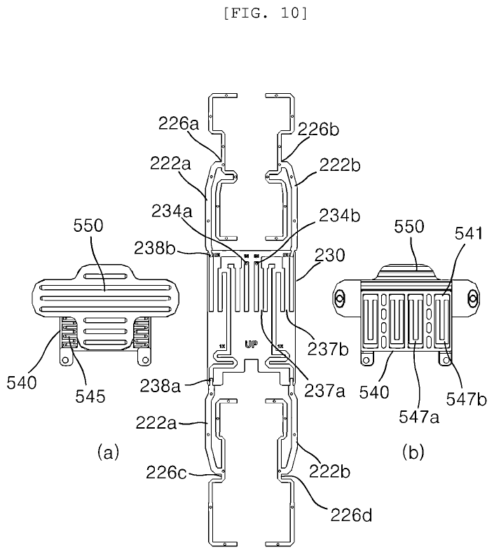

In this case, as referred in FIG. 10, two first power failure points 237a and two second power failure points 237b, which have a first input end 234a and a second input end 234b that are described later as their starting points, are provided within one pattern PCB 230. Accordingly, four terminal blocks 541 of the variable switch panel 540 may be provided and fixed and installed in the block installation grooves 543 of the variable switch panel 540.

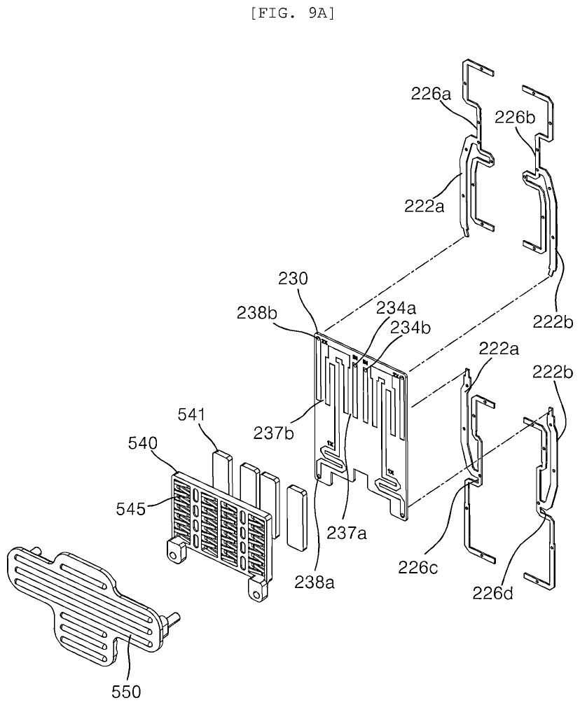

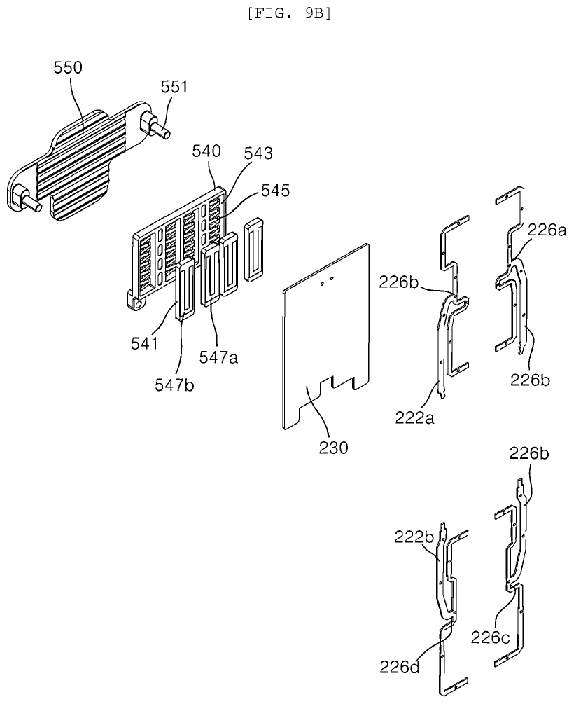

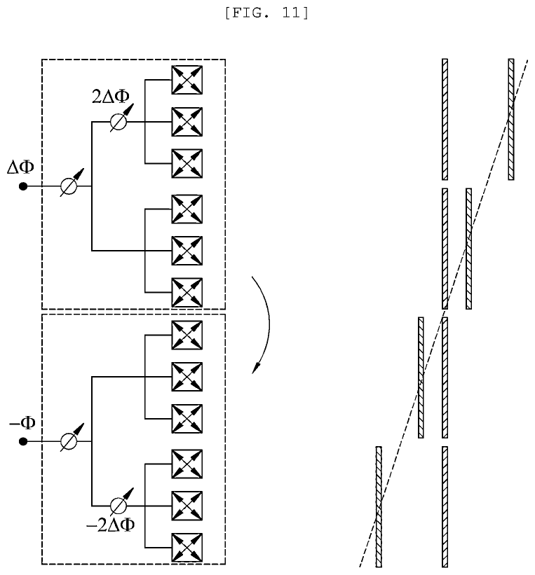

FIGS. 9A and 9B are exploded perspective views of the front part and the rear part, illustrating a form in which the switch panel of the phase shifter has been disposed in the pattern PCB of the radiation element module, among the components of FIG. 3. FIG. 10 is a plan view of FIG. 9A. FIG. 11 is a circuit diagram and a phase difference diagram for describing the principle of a phase shift form that is performed in an RF stage using the phase shifter of the antenna apparatus according to an embodiment of the present disclosure.

Referring to FIG. 10, the first electrical conduction pattern terminal 547a performs a role to connect the first power failure points 237a. The second electrical conduction pattern terminal 547b performs a role to connect the second power failure points 237b.

The variable switch panel 540 may be provided in a slider type in which the variable switch panel connects the first power failure point 237a and the second power failure point 237b and also changes the length of a transmission line that is patternized and printed on the pattern PCB 230 while being moved in a straight line in up and down directions thereof within a predetermined range. That is, when the phase shift driving motor 510 is driven, the two variable switch panels 540 may be provided to simultaneously slide at the same distance in the up and down vertical directions.

Furthermore, as referred in FIGS. 9A and 9B, the elastic ribs 545 that are provided within the block installation grooves 543 of the variable switch panel 540 perform a role to supplement a contact point function by performing a role to elastically support the multiple terminal blocks 541 toward the pattern PCB 230 that is disposed behind the multiple terminal blocks.

That is, the elastic ribs 545 may perform a role to continuously maintain contact points by adding an elastic force so that the first electrical conduction pattern terminals 547a and second electrical conduction pattern terminals 547b of the terminal block 541, which are installed in the block installation grooves 543 of the rear part of the variable switch panel 540, sufficiently adhere to the first power failure point 237a and second power failure point 237b of the pattern PCB 230.

In the antenna apparatus 100 constructed as above according to an embodiment of the present disclosure, the phase shifter 500 provides an advantage in that space utilization is improved, because in particular, the variable switch panel 540 is provided to slide and move in the separation space between the front surface of the front mounting panel 210B of the antenna element mounting panel 210 and the rear surface of the array antenna element 250 and the phase shift driving motor 510, the horizontal mounting bar 520, and the vertical mounting bar 530 which occupy a relatively large space and various types of components (the horizontal bracket part 560, etc.) for coupling them are separately disposed on the rear surface side of the rear mounting panel 210C.

Meanwhile, referring to FIGS. 9A to 10, the pattern PCB 230 that has been patternized and printed to have two input ends (hereinafter referred to as the “first input end 234a and the second input end 234b”) formed to penetrate the pattern PCB forward and backward and the first power failure point 237a and the second power failure point 237b that are extended from the input ends and form two variable circuits, and the pattern transmission line 220 that forms a long-side feeding connection end 238a and a short-side feeding connection end 238b that mediate electrical connections to a one-side transmission line 222a and the other-side transmission line 222b, which are described later, each having two output ends (hereinafter output ends that are branched from the first input end 234a are referred to as a “first output end 226a” and a “third output end 226c”, and output ends that are branched from the second input end 234b are referred to as a “second output end 226b” and a “fourth output end 226d”) that are branched from the two input ends (the first input end 234a and the second input end 234b) of the pattern PCB 230, respectively, may be disposed in the front mounting panel 210B that is stacked and disposed on the front surface of the antenna element mounting panel 210.

The first output end 226a and third output end 226c of the long-side feeding connection end 238a and the short-side feeding connection end 238b of the pattern transmission line 220 that are branched from the first input end 234a of the pattern PCB 230 may be arranged to be spaced apart from each other in a vertical (V) direction of the front mounting panel 210B. The second output end 226b and fourth output end 226d of the long-side feeding connection end 238a and the short-side feeding connection end 238b of the pattern transmission line 220 that are branched from the second input end 234b of the pattern PCB 230 may be arranged to be left and right symmetrical to the first output end 226a and the third output end 226c.

That is, the first output end 226a and the third output end 226c that are branched from the first input end 234a of the two input ends and that are become conductive may be arranged to be spaced apart from each other on the left in the vertical (V) direction on the basis of the pattern PCB 230. The second output end 226b and the fourth output end 226d that are branched from the second input end 234b of the two input ends and that are become conductive may be arranged to be spaced apart from each other on the right in the vertical direction on the basis of the pattern PCB 230.

That is, as referred in FIGS. 9A and 9B, two pattern transmission lines 220 on upper and lower sides of the pattern PCB 230, respectively, are connected to form a group. The pattern transmission line 220 that is disposed on the lower side of the pattern PCB 230 may be connected to the long-side feeding connection end 238a that is extended downward so that the one-side transmission line 222a and the other-side transmission line 222b pass through only the first power failure point 237a from the first input end 234a and the second input end 234b. The pattern transmission line 220 that is disposed on the upper side of the pattern PCB 230 may be connected to the short-side feeding connection end 238b that is extended upward so that the one-side transmission line 222a and the other-side transmission line 222b pass through both the first power failure point 237a and the second power failure point 237b from the first input end 234a and the second input end 234b.

Therefore, a power feeding signal is input from each TRx module to each of the input ends (the first input end 234a and the second input end 234b). Each of the power feeding signals that are transmitted through the input ends 234a and 234b is output to each of output ends (the first output end to the fourth output ends 226a to 226d) through each transmission line that becomes conductive through a contact point for an inner variable circuit and outer variable circuit of the variable switch panel 540, which are described later.

Furthermore, each of the output ends (the first output end to the fourth output ends 226a to 226d) may be branched into two and extended to have the same transmission line length so that a pair of array antenna elements 250 is connected to the two output ends up and down.

More specifically, four array antenna elements 250 may be disposed on the front surface of the front mounting panel 210B of the antenna element mounting panel 210 up and down. The four array antenna elements 250 may be connected to the one-side transmission line 222a and the other-side transmission line 222b of each pattern transmission line 220, which are connected to upper and lower sides of one pattern PCB 230. An extension end that is branched from each of the output ends of the one-side transmission line 222a and the other-side transmission line 222b may be connected to every two array antenna element 250 for power feeding.

In this case, referring to FIG. 10, the one-side transmission line 222a may be defined as a transmission line having a form in which the first output end 226a is connected to the short-side feeding connection end 238b that is branched and extended from the first input end 234a, and may be defined as a transmission line having a form in which the third output end 226c is connected to the long-side feeding connection end 238a that is branched and extended from the first input end 234a. The other-side transmission line 222b may be defined as a transmission line having a form in which the second output end 226b is connected to the short-side feeding connection end 238b that is branched and extended from the second input end 234b, and may be defined as a transmission line having a form in which the fourth output end 226d is connected to the long-side feeding connection end 238a that is branched and extended from the second input end 234b.

The first output end 226a, among the first output end 226a and the third output end 226c that are branched from the first input end 234a as described above, may be disposed on a relatively upper side of a left end thereof in a vertical direction thereof. The third output end 226c, among the first output end 226a and the third output end 226c, may be disposed on a relatively lower side of a left end thereof in a vertical direction thereof.

Furthermore, the second output end 226b, among the second output end 226b and the fourth output end 226d that are branched from the second input end 234b, may be disposed on a relatively upper side of a right end thereof in a vertical direction thereof. The fourth output end 226d, among the second output end 226b and the fourth output end 226d, may be disposed on a relatively lower side of a right end thereof in a vertical direction thereof.

Therefore, the first output end 226a and the second output end 226b may be placed at the same height over the first input end 234a and the second input end 234b. The third output end 226c and the fourth output end 226d may be placed at the same height under the first input end 234a and the second input end 234b.

In this case, the first power failure point 237a may be defined as a part at which the one-side transmission line 222a or the other-side transmission line 222b is disconnected at a location close to the first input end 234a and the second input end 234b before e one-side transmission line or the other-side transmission line is branched from the first input end 234a or the second input end 234b to the long-side feeding connection end 238a and the short-side feeding connection end 238b, and may be defined as a part at which the one-side transmission line or the other-side transmission line is disconnected before e one-side transmission line or the other-side transmission line reaches the short-side feeding connection end 238b after being branched into the long-side feeding connection end 238a and the short-side feeding connection end 238b.

To explain this in more detail with reference to FIG. 10, the inner variable circuit (reference numeral not indicated) that is extended in a straight line in the up and down directions from the first input end 234a and the second input end 234b and that has the first power failure point 237a, and the outer variable circuit (reference numeral not indicated) that is branched into the long-side feeding connection end 238a and the short-side feeding connection end 238b from the outside of the inner variable circuit, that is extended in a straight line in the up and down directions, and that has the second power failure point 237b are patternized and printed on the front surface of the pattern PCB 230. The one-side transmission line 222a and the other-side transmission line 222b of the pattern transmission line 220 may be connected to an upper part of the long-side feeding connection end 238a and a lower part of the short-side feeding connection end 238b, respectively, for power feeding.

Therefore, in response to a power feeding signal that is received from the TRx module, only the first power failure points 237a corresponding to the inner variable circuit, that is, transmission lines that connect the first output end 226a from the first input end 234a and the second output end 226b from the second input end 234b, respectively, may be electrically conductive as contact points through the first electrical conduction pattern terminal 547a of the variable switch panel 540 that is described later. In response to a power feeding signal that is received from the TRx module, the second power failure points 237b corresponding to the outer variable circuit, in addition to the first power failure points 237a corresponding to the inner variable circuit, that is, transmission lines that connect the third output end 226c from the first input end 234a and the fourth output end 226d from the second input end 234b, respectively, may be electrically conductive as simultaneous contact points through the first electrical conduction pattern terminal 547a and second electrical conduction pattern terminal 547b of the variable switch panel 540 that are described later.

Meanwhile, the first electrical conduction pattern terminal 547a and the second electrical conduction pattern terminal 547b that implement a phase difference while making electrically conductive the first power failure points 237a and the second power failure points 237b (i.e., the variable circuits at the two places) may be provided in the rear part of the variable switch panel 540.

Therefore, on the premise that two pattern PCBs 230 are arranged to be spaced apart from each other in a vertical direction thereof, if two variable switch panels 540 are also arranged to be spaced apart from each other in the vertical direction so that the two variable switch panels simultaneously operate, a vertical phase difference between the output ends 226a to 226d by the simultaneous operations of the two variable switch panels 540 may have a straight line tilt distribution with respect to a reference same phase surface.

For example, the phase shifter 500 may change a length ratio from a branch point that is branched from one input end to the short-side feeding connection end 238b and the long-side feeding connection end 238a so that the length ratio has a predetermined ratio, when the first power failure point 237a and the second power failure point 237b electrically become conductive by the first electrical conduction pattern terminal 547a and the second electrical conduction pattern terminal 547b.

In this case, the predetermined ratio needs to be set so that beam phase values of the radiation elements that constitute the antenna array have linearity. For example, the length ratio of the long-side feeding connection end 238a and the short-side feeding connection end 238b that are related to the two input ends 234a and 234b has the predetermined ratio. In this case, it is preferred that the predetermined ratio is 3:1.

That is, the variable switch panel 540 may implement a phase difference by changing the total length of the one-side transmission line 222a and the other-side transmission line 222b while sliding and moving in a straight line at a predetermined distance in the up and down directions.

In other words, it is preferred that the length ratio of physical transmission lines from branch points from the first input end 234a and the second input end 234b to the long-side feeding connection end 238a and the short-side feeding connection end 238b to the long-side feeding connection end 238a and the short-side feeding connection end 238b, respectively, is 3:1 (1:3, that is, an opposite thereof).

Meanwhile, the shape of the pattern that is printed and formed on the front surface of the pattern PCB 230 may be defined as an uneven shape including the inner variable circuit and the outer variable circuit.

In this case, the inner variable circuit may mean a pattern part prior to the branch from the first input end 234a or the second input end 234b to the long-side feeding connection end 238a and the short-side feeding connection end 238b. The outer variable circuit may mean a pattern part printed up to the short-side feeding connection end 238b after the branch into the long-side feeding connection end 238a and the short-side feeding connection end 238b.

FIG. 11 is a circuit diagram and a phase difference diagram for describing the principle of a phase shift form that is performed in an RF stage using the phase shifter of the antenna apparatus according to an embodiment of the present disclosure.

As already described in [Background Art], in order to implement the mirror symmetry structure although the length of the transmission line is changed in the RF stage, the phase of a signal that is supplied to at least two array antenna elements 250, among the four array antenna elements 250, requires a support task in the digital stage.

However, the full analog phase shifter 500 constructed as above according to an embodiment of the present disclosure has an advantage in that it does not require the support task in the digital stage because the full analog phase shifter is rotatably provided so that in response to a power feed signal that is received from one TRx module (means transmission and reception elements that are mounted on a main board or an amplification element part (not illustrated)), the lengths of the one-side transmission line 222a and the other-side transmission line 222b are changed at a predetermined ratio by the first electrical conduction pattern terminal 547a and second electrical conduction pattern terminal 547b of the variable switch panel 540 at the first power failure point 237a prior to the branch from each input end to the two output ends (or the long-side feeding connection end 238a and the short-side feeding connection end 238b) and the second power failure point 237b after the branch.

That is, as referred in FIG. 10, the first power failure point 237a prior to the branch from the first input end 234a to the long-side feeding connection end 238a and the short-side feeding connection end 238b and the first power failure point 237a prior to the branch from the second input end 234b to the long-side feeding connection end 238a and the short-side feeding connection end 238b can implement a desired phase shift value by changing the physical lengths of the one-side transmission line 222a and the other-side transmission line 222b through the first electrical conduction pattern terminal 547a of the variable switch panel 540 so that a phase varies by ΔΦ and −ΔΦ. The second power failure point 237b after the branch from the first input end 234a to the long-side feeding connection end 238a and the second power failure point 237b after the branch from the second input end 234b to the long-side feeding connection end 238a can implement a desired phase shift value by changing the physical lengths of the other-side transmission line 222b through the second electrical conduction pattern terminal 547b of the variable switch panel 540 so that a phase varies by 2ΔΦ and −2ΔΦ.

In this case, the phase shift values of the four array antenna elements 250 on the basis of the same phase surface can form a linear phase distribution, so that the mirror symmetry structure having the most efficient beamforming performance can be implemented.

More specifically, assuming that the pattern transmission lines 220 are disposed in parallel in up and down vertical directions thereof on the basis of the two pattern PCBs 230, a first beam output part between the first output end 226a and the second output end 226b and a second beam output part between the third output end 226c and the fourth output end 226d, which are provided in the pattern transmission line 220 on the upper side thereof in the vertical direction, may be defined. Likewise, a third beam output part between the first output end 226a and the second output end 226b and a fourth beam output part between the third output end 226c and the fourth output end 226d, which are provided in the pattern transmission line 220 on the lower side thereof in the vertical direction, may be defined.

In this case, by the simultaneous operations of the two variable switch panels 540, the second beam output part and the third beam output part may each change the length of the transmission line so that the length is shifted by ±ΔΦ with respect to a reference same phase surface, and the first beam output part and the fourth beam output part may each change the length of the transmission line so that the length is shifted by ±Δ3Φ with respect to a reference same phase surface.

As described above, according to the full analog phase shifter 500 according to an embodiment of the present disclosure and the antenna apparatus 100 including the full analog phase shifter, there are advantages in that a linear phase distribution having a straight line form can be formed and a mirror symmetry structure capable of the most efficient beamforming performance can be implemented, through a change in the physical length of the transmission line according to each of the contact points of the first electrical conduction pattern terminal 547a and second electrical conduction pattern terminal 547b of the variable switch panel 540 at each of the first power failure point 237a and the second power failure point 237b when a signal is received from the TRx module without a need for offset corrections (i.e., a support task) for correcting a phase difference in the digital stage.

The antenna apparatus according to an embodiment of the present disclosure has been described above in detail with reference to the accompanying drawings. However, an embodiment of the present disclosure is not essentially limited to the aforementioned embodiment, and may include various modifications and implementations within an equivalent range thereof by a person having ordinary knowledge in the art to which the present disclosure pertains. Accordingly, the true range of a right of the present disclosure will be said to be defined by the appended claims.

### INDUSTRIAL APPLICABILITY

The present disclosure provides the full analog phase shifter capable of implementing a linear phase distribution having mirror symmetry through only a phase shift in the RF stage without a phase shift in the digital stage.

1. A full analog phase shifter comprising:
a variable switch panel comprising a first electrical conduction pattern terminal and a second electrical conduction pattern terminal; and
a pattern PCB on which multiple array antenna elements are disposed and transmission lines with which the first electrical conduction pattern terminal and the second electrical conduction pattern terminal come into contact are patternized and printed,
wherein assuming that the two variable switch panels are disposed in up and down directions thereof, the two variable switch panels are provided in a slider type in which the two variable switch panels slide in the up and down vertical directions so that a phase for the multiple array antenna elements has a linear distribution on a reference same phase surface by a phase shift according to contact points between the first electrical conduction pattern terminal and the second electrical conduction pattern terminal and the transmission lines.

2. The full analog phase shifter according to claim 1, wherein the two variable switch panels are provided to simultaneously slide an identical distance in the up and down vertical directions.

3. The full analog phase shifter according to claim 1, further comprising a pattern transmission line that is connected to the pattern PCB and that comprises a one-side transmission line and the other-side transmission line that are electrically connected to the multiple array antenna elements for power feeding.

4. The full analog phase shifter according to claim 3, wherein the one-side transmission line and the other-side transmission line are formed to have an identical length ratio.

5. The full analog phase shifter according to claim 3, wherein:
the one-side transmission line and the other-side transmission line are provided in upper and lower parts of the pattern PCB, respectively, and are each branched into two from an output end corresponding to each front end thereof and are extended, and
a singular number of array antenna elements, among the multiple array antenna elements, is connected to a pair of extension ends that is branched from the output end and disposed at an identical height, for power feeding.

6. The full analog phase shifter according to claim 3, wherein the first electrical conduction pattern terminal and second electrical conduction pattern terminal of the variable switch panel come into contact with an inner variable circuit prior to a branch from two input ends to a long-side feeding connection end and a short-side feeding connection end that are connected to the one-side transmission line and other-side transmission line of the pattern transmission lines and an outer variable circuit after the branch, respectively.

7. The full analog phase shifter according to claim 6, wherein:
the long-side feeding connection end and the short-side feeding connection end related to each of the two input ends are provided to have a length ratio of a predetermined ratio, and
the predetermined ratio is 3:1.

8. The full analog phase shifter according to claim 6, wherein:
the inner variable circuit and the outer variable circuit are patternized and printed to have a first power failure point and a second power failure point at each of which a part of the transmission line between the long-side feeding connection end and the short-side feeding connection end from each of the input ends has been broken,
the first electrical conduction pattern terminal of the variable switch panel makes electrically conductive the first power failure point corresponding to the inner variable circuit, and
the second electrical conduction pattern terminal of the variable switch panel makes electrically conductive the second power failure point corresponding to the outer variable circuit.

9. The full analog phase shifter according to claim 8, wherein a first output end and a third output end that are branched from a first input end of the two input ends are arranged to be spaced apart from each other in a vertical (V) direction on a left side of the pattern PCB.

10. The full analog phase shifter according to claim 8, wherein a second output end and a fourth output end that are branched from a second input end of the two input ends are arranged to be spaced apart from each other in a vertical (V) direction on a right side of the pattern PCB.

11. The full analog phase shifter according to claim 9, wherein:
assuming that the two pattern PCBs are arranged to be spaced apart from each other in the vertical direction, the two variable switch panels are also provided to be spaced apart from each other in the vertical direction so that the two variable switch panels simultaneously operated, and
a vertical phase difference at each output end by the simultaneous operation of the two variable switch panels has a straight line tilt distribution with respect to the reference same phase surface.

12. The full analog phase shifter according to claim 11, further comprising:
a phase shift driving motor provided on a rear surface side of an antenna element mounting panel in which the variable switch panel and the pattern PCB are installed;
a horizontal mounting bar driven in the up and down directions by receiving a driving force of the phase shift driving motor; and
multiple vertical mounting bars connected to two variable switch panels provided to be spaced apart from each other in the vertical direction and each having one end connected to the horizontal mounting bar and the other end vertically extended upward or downward.

13. The full analog phase shifter according to claim 12, wherein:
the two variable switch panels are disposed to be spaced apart from each other at a predetermined distance in a horizontal (H) direction in multiple columns, and
the multiple vertical mounting bars are provided in the horizontal mounting bar so that the multiple vertical mounting bars simultaneously connect the two variable switch panels that are disposed in multiple columns in the horizontal direction.

14. The full analog phase shifter according to claim 12, wherein the horizontal mounting bar comprises:
a rear mounting bar provided to slide and move up and down through a medium of an up and down moving block screwed onto a screw rod that is connected to a rotation shaft of the phase shift driving motor; and
a front mounting bar coupled to a front surface side of the antenna element mounting panel so that the front mounting bar operates in conjunction with the rear mounting bar.

15. The full analog phase shifter according to claim 14, wherein a sliding guide hole that provides guidance to the up and down moving of the rear mounting bar and the front mounting bar is formed in the antenna element mounting panel.

16. The full analog phase shifter according to claim 15, wherein:
the antenna element mounting panel comprises a reflecting panel, a front mounting panel disposed on a front surface of the reflecting panel, and a rear mounting panel disposed on a rear surface of the reflecting panel, and
the sliding guide hole is formed in the reflecting panel corresponding to an outside of left ends and right ends of the front mounting panel and the rear mounting panel.
